(19) United States
(12) Patent Application Publication
(10) Pub. No.: US 2025/0206931 A1
(43) Pub. Date: Jun. 26, 2025

(54) POLYMER COMPOSITION FOR IMPROVED GRADE PLASTICS FROM RECYCLED MATERIAL

(71) Applicant: QCP Holding B.V., Geleen (NL)

(72) Inventors: Francois Essers, Geleen (NL); Johannes Venerius, Geleen (NL)

(73) Assignee: QCP Holding B.V., Geleen (NL)

(21) Appl. No.: 18/848,697

(22) PCT Filed: Mar. 23, 2023
(86) PCT No.: PCT/EP2023/057457

§ 371 Date: Sep. 19, 2024

(30) Foreign Application Priority Data
Mar. 23, 2022 (EP) 22163764.8

(51) Int. Cl. C08L 23/12; C08K 3/34; C08K 5/14; C08L 23/26

(52) U.S. Cl. CPC C08L 23/12; C08K 3/34; C08K 5/14; C08K 2201/003; C08L 2023/40; C08L 2205/025; C08L 2205/03; C08L 2207/02; C08L 2207/20

(57) ABSTRACT

A polymer composition made from or containing:
(a) 60-80 wt % of a recycled polypropylene (rPP);
(b) 0-0.03 wt % of a peroxide;
(c) 3-7 wt % of a heterophasic propylene ethylene copolymer; and
(d) 10-30 wt % of a polyolefin elastomer (POE);
   wherein components (a) to (d) combine to 100%, and wherein the melt flow rate of component (a) has been increased by reaction with a peroxide to be in the range of 60 to 80 g/10 min. determined according to ISO 1133 at 2.16 kg at 230° C.

### FIELD OF THE INVENTION

In general, the present disclosure relates to the field of chemistry. More specifically, the present disclosure relates to polymer chemistry. In particular, the present disclosure relates to a polymer composition made from or containing recycled polypropylene (PP) and recycled polyethylene (PE), manufacturing articles therefrom, the manufactured articles, and a process for preparing the polymer composition.

### BACKGROUND OF THE INVENTION

The omnipresence of plastic packaging and the importance of environmental policy have led to the increased importance of recycled plastic materials.

The recycling of paper, textiles, glass or metals is already carried out on a large scale, whether by separate collection or by sorting of the recyclate. The recycling of plastic waste and re-use of plastics is also increasing.

Virgin polymer composition replacement is considered to represent the way forward for solving the global plastic waste problem, stopping the depletion of natural resources, and facilitating a circular economy.

To date, recycled polymer compositions are available, in the form of flakes or granules, which are obtained from the collection of polyolefin packaging, containers or films. Commercially-available, recycled polymer composition is made from or containing between 5-8 wt % of recycled polyolefin and between 92-95 wt % of virgin polyolefins.

### SUMMARY OF THE INVENTION

In a general embodiment, the present disclosure provides a polymer composition made from or containing:
(a) 60-80 wt % of a shifted recycled polypropylene (s-rPP);
(b) 0-0.03 wt % of a peroxide;
(c) 3-7 wt % of a heterophasic propylene ethylene copolymer; and
(d) 10-30 wt % of a polyolefin elastomer (POE);
   wherein the amount of components (a) to (d) are defined relative to the sum of (a)+(b)+(c)+(d) of the polymer composition, and wherein the melt flow rate of component (a) is in the range of 60 to 80 g/10 min., determined according to ISO 1133 at 2.16 kg at 230° C.

In some embodiments, the present disclosure provides a method for preparing the polymer composition, polymer articles prepared therefrom, and a process of preparing the articles. In some embodiments, the articles are prepared by injection molding.

### DETAILED DESCRIPTION OF THE INVENTION

As used herein, the expression “comprising” refers to the components (a) to (d) being present in defined amounts. In some embodiments, other components are present. In some embodiments, other components are present in amounts up to 10 wt % of the total of components (a) to (d). In some embodiments, the other components are selected from the group consisting of fillers, colorants and additives. In some embodiments, the amounts of components (a)+(b)+(c)+(d) form at least 90 wt % of the polymer composition.

### Component (a): Shifted Recycled Polypropylene

In some embodiments, the shifted recycled polypropylene (s-rPP) is obtained by processing a recycled PP (rPP) with an organic peroxide to a higher melt flow rate and a lower molecular weight.

In some embodiments, the rPP raw material is made from or containing plastic waste. In some embodiments, the plastic waste is made from or containing post-consumer waste (PCW) PP packaging waste. In some embodiments, the post-consumer waste (PCW) PP packaging waste is selected from the group consisting of detergent and shampoo bottles, dairy pots, and meat trays. In some embodiments, the rPP raw material waste is pre-sorted by waste management companies. In some embodiments, the rPP source is waste material collected under the DSD 324 (05-2012) and DSD 324-1 standard (03-2018).

In some embodiments, the rPP DSD 324 (05-2012) raw material is made from or containing at least one used, residue-drained, rigid, system-compatible item made from or containing polypropylene. In some embodiments, the used, residue-drained, rigid, system-compatible item is selected from the group consisting of bottles, cups, trays, and secondary components selected from the group consisting of lids and labels. In some embodiments, the rPP DSD 324 (05-2012) raw material is made from or containing a maximum total amount of impurities 6% by mass. In some embodiments, the impurities in the rPP DSD 324 (05-2012) raw material are made from or containing other metal items<0.5% by mass, rigid PE items<1% by mass, expanded plastics<0.5% by mass, plastic films<2% by mass and other residues<3% by mass. In some embodiments, the expanded plastics are made from or containing EPS items. In some embodiments, impurities in rPP DSD 324 (05-2012) raw material are selected from the group consisting of glass, paper, board, cardboard, composite paper/cardboard materials, aluminized plastics, other materials, and compostable waste. In some embodiments, the composite paper/cardboard materials are liquid packaging boards. In some embodiments, the other materials are selected from the group consisting of rubber, stones, wood, textiles, and nappies. In some embodiments, the compostable waste is selected from the group consisting of food and garden waste.

In some embodiments, the rPP satisfies PP DSD 324-1 standard (03-2018), which is comparable to the PP DSD 324 standard. In some embodiments, the rPP is made from or containing more film material, up to about 10 wt %, than permitted under PP DSD 324. In some embodiments, the film material is made from or containing both rPP film and PE film. In some embodiments, the rPP film is bioriented PP (BOPP) film. In some embodiments, the PP DSD 324-1 standard (03-2018) raw material is made from or containing a maximum total amount of impurities 4% by mass. In some embodiments, the impurities are made from or containing other metal items<0.5% by mass, rigid PE items<1% by mass, expanded plastics<0.5% by mass, paper, cardboard, carton, composite paper/cardboard materials<1% by mass, and other residues<3% by mass. In some embodiments, the expanded plastics are made from or containing EPS items. In some embodiments, the composite paper/cardboard materials are liquid packaging boards. In some embodiments, the impurities are selected from the group consisting of glass, aluminized plastics, other materials, and compostable waste. In some embodiments, the other materials are selected from the group consisting of rubber, stones, wood, textiles, and nappies. In some embodiments, the compostable waste is selected from the group consisting of food and garden waste.

In some embodiments, the rPP is made from or containing from 25-75 parts by weight of 100 parts of packaging material (BOPP) and from 75-25 pbw of rubber-containing injection molded material. In some embodiments, the injection molded material is made from or containing rubbers, thermoplastic elastomers (TPE), ethylene propylene diene methylene (EPDM), or ethylene propylene rubber (EPR). In some embodiments, the rubber is C2-C3 rubber.

In some instances, the melt flow rate of a rPP ranges between 10 and 20, determined using the ISO 1133-1:2011, 2.16 kg, T=230° C., when no treatment of the rPP has taken place. This MFR is not low enough for making the polymer composition of the present disclosure.

In some embodiments, the shifted recycled PP has a melt flow rate in the range of 60 to 80 g/10 min, determined using ISO 1133-1:2011, 2.16 kg, T=230° C.

In some embodiments, the MFR of component (a) is in the range of 65 to 75 g/10 min.

In some embodiments, the s-rPP undergoes a MFR shift by reaction of rPP with a peroxide before addition of the other components of the composition. It is believed that if the other components (heterophasic propylene ethylene copolymer and polyolefin elastomer (POE)) are present during the shifting of the rPP, the resulting composition would lack the balance of properties for preparing the polymer articles.

In some embodiments, the shifting of the rPP is carried out with an organic peroxide, alternatively with 2,5-Dimethyl-2,5-di(tert-butylperoxy)hexane (CAS 78-63-7). In some embodiments, the shifting is carried out with 0.1-0.3 wt % of an organic peroxide. In some embodiments, the organic peroxide is present as a masterbatch, wherein the peroxide is dispersed in a polymer like polypropylene (PP). In some embodiments, 10 wt % organic peroxide is dispersed in 90 wt % PP, thereby providing a 10 wt % masterbatch. In some embodiments and for shifting the rPP, 1-3 wt % of a 10% masterbatch of a peroxide is used. In some embodiments, other masterbatches are used.

In some embodiments, shifting takes place in an extruder. In some embodiments, the extruder is operated at temperatures between 20° and 270° C.

In some embodiments, the s-rPP is present between 60-80 wt %, alternatively 60-77.5 wt %, alternatively between 62-75 wt %, relative to the sum of (a)+(b)+(c)+(d) of the polymer composition. In some instances, relative to the sum of (a)+(b)+(c)+(d) of the polymer composition is defined as relative to the sum of (a) to (d) of the polymer composition.

### Component (b), Peroxide

Optionally, the s-rPP, the heterophasic propylene ethylene copolymer. and the polyolefin elastomer (POE) are blended together with a small amount of peroxide, component (b). In some embodiments, component (b) is present as a PP masterbatch. In some embodiments, the peroxide of the PP masterbatch is present in a weight ratio of peroxide to PP of 1:100-1:25, alternatively between 1:50-1:30. In some embodiments, the amount of peroxide component b ranges between 0 and 0.03 wt % (based on wt % peroxide) relative to the sum of components a+b+c+d.

Component (b) should not be confused with the peroxide used for shifting the rPP to s-rPP, carried out before blending the different components to make the polymer composition.

In some embodiments, component (b) is used for fine tuning the flow properties of the polymer composition.

In some embodiments, the peroxides are used as crosslinking agents in other applications. In some embodiments, the peroxide is an organic peroxide. In some embodiments, the peroxide is 2,5-dimethyl-2,5-di(tert-butylperoxy)hexane (DBPH), which is commercially available as Trigonox® 101. In some embodiments, the peroxide is 2,5-dimethyl-2,5-di(tert-butylperoxy)hexyne-3, dicumyl peroxide.

### Component (c), Heterophasic Propylene Ethylene Copolymer

In some embodiments, the heterophasic propylene ethylene copolymer is as described in United States Patent Application Nos. US2020339794 and US2020263013, incorporated herein by reference. In some embodiments, the heterophasic propylene ethylene copolymer has:
i) a content of ethylene derived units ranging from 6.0 wt % to 16.0 wt %;
ii) a fraction soluble in xylene at 25° C. ranging from 15 wt % to 45 wt %;
iii) an intrinsic viscosity (n) of the fraction soluble in xylene at 25° C. ranging from 4.0 to 9.0 dl/g; and
iv) a melt flow rate, measured according to ISO 1133 at 230° C. with a load of 2.16 kg, ranging from 0.3 to 50.0 g/10 min, alternatively from 0.5 to 5.0 g/10 min.

In some embodiments, the heterophasic propylene ethylene copolymer is LyondellBasell Hifax X 1956 A. In some embodiments, component (c) is used in amounts varying from 3-7 wt %, alternatively 4-6 wt %, relative to the sum of (a) to (d) of the polymer composition.

### Component (d), Polyolefin Elastomer

Component (d) is an ethylene alpha-olefin copolymer (POE). In some embodiments, the POE is selected from the group consisting of C₂-C₄ copolymers, C₂-C₆ copolymers, and C₂-C₈ copolymers. In some embodiments, the POE is a C₂-C₆ copolymer or a C₂-C₈ copolymer with between 70-80 wt % ethylene, alternatively between 73-78 wt %, alternatively between 74-77 wt %; wherein wt % is relative to the POE.

In some embodiments, the POE is made from or containing an ethylene (C₂) octene (C₈) metallocene rubber with a blocky structure. In some embodiments, the POE has a density of between 0.85-0.89, alternatively between 0.855-0.885, alternatively between 0.86-0.875.

In some embodiments, the POE has an MFR of between 0.3-1, alternatively between 0.4-0.8, alternatively between 0.45-0.7 (190° C., 2.16 kg).

In some embodiments, the POE is selected from the group consisting of Infuse or Engage polymers, which are commercially available from Dow. In some embodiments, the Infuse polymer is selected from the group consisting of Infuse 9107 and Infuse 9077. In some embodiments, the Engage polymer is Engage XLT8677. In some embodiments, the POE is Infuse 9077.

In some embodiments, the POE is present at between 10-30 wt %, alternatively 15-25 wt %, alternatively at about 20 wt %, relative to the sum of (a) to (d) of the polymer composition.

### Component e) Talcum

In some embodiments, the composition contains talcum. In some embodiments, the talcum is unmodified. In some embodiments, the talcum does not have a surface coating or surface treatment. In some embodiments, the talcum is an alpha nucleating agent. In some embodiments, the talcum is hydrated magnesium-silicate or Steamic 00S DF.

In some embodiments, the talcum is a very finely ground talcum. In some embodiments, the talcum has a D50 of less than 4 microns, alternatively less than 3 microns, alternatively less than 2.5 microns. It is believed that very finely ground talcum increases impact and tensile modulus in combination with a recycle PP and acts as a nucleating agent for the composition, thereby adding to the mechanical properties of the composition. The D50 is measured by sedigraph, sedimentation analysis, Stokes Law (ISO 13317-3).

It is believed that the talcum increases the stiffness and strength of the polymer composition and produced articles. It is further believed that the talcum content impacts the flow of the polymer composition in the molding process. It is further believed that the talcum content impacts the flow of the polymer composition in the molding process for thin-walled applications.

In some embodiments, the talcum is present at between 1-10 wt %, alternatively between 1-5 wt %, alternatively between 2-5 wt %, alternatively between 2.5-4 wt %, within the polymer composition. In some embodiments, the talcum content is between 2.5 and 3.5 wt % relative to the total composition.

It is believed that amounts of lower than 1 wt % talcum do not improve the properties of the composition, while amounts of >10 wt % give a composition having too high density for some applications. It is further believed that the amount of tigerstripes tend to increase above 10 wt %.

### Additional Components

In some embodiments, the polymer composition is made from or containing additional components. In some embodiments, the additional components are selected from the group consisting of fillers, colorants, processing aids, other polymers, and recycle streams.

In the present disclosure, component (a) undergoes a shifting reaction with a peroxide before the additional components are added.

The present disclosure is illustrated by the following examples.

### EXAMPLES

A series of experiments were performed. Experiments 1-3, and 5-7 were comparative examples, wherein a s-rPP was used that had not undergone a pretreatment to shift the MFR, and also no component c (Hifax) was added.

The recipes are provided in Table 1, below.

Experiments C1-C3 showed properties with acceptable tiger striping, high modulus, and low elongation at break and at yield, thereby yielding brittle materials. The Charpy impact was poor by a factor of 10 lower. The addition of Kraton rubber from C1 to C2 to C3 did not sufficiently improve the Charpy.

In experiments C5, the amount of Infuse 9077 was increased relative to C1-C3, and a rPE was added. As a result, the MFR was low, elongation at break and at yield were low, and tiger stripes were high.

Experiment C6 applied a different DOW Infuse 9177, in higher amounts compared to C1-C3. The properties were comparable to experiments C1-C3: low Charpy impact and elongation values. This example showed higher amounts of tiger stripes.

Experiment C7 compared to C5: 10 wt % Infuse 9177 was applied. Charpy impact was low, elongation at break and at yield were low, and tiger stripes were high.

Experiments 4(a-d) had an E-modulus greater than 800 N/mm² with improved impact strength at room temperature and cold temperature.

Experiments 4(a-d) provided molded products with no visual tiger stripes or other surface defects.

The results are provided in Table 2, below.

| Sample | Description |
|---|---|
| QCP PP300U | Shifted PP, DSD324 circular |
| (MFR 70) grey or | PP (MFR 10-15, |
| ivory | 2.16 kg/230° C.) |
| QCP PP300t (MFR 50) grey or | Shifted PP, DSD324 circular |
| ivory | PP (MFR 10-15, 2.16 kg/230° C.) |
| LyondellBasell Hifax X 1956 A | Broad molecular weight PP copolymer |
| DOW Infuse 9077 | C2C8 metallocene copolymer |
| | (MFR 0.5 g/10 min (2.16 |
| | kg/190° C.) |
| DOW Infuse 9177 | C2C8 metallocene copolymer |
| | (MFR 1 g/10 min @(2.16 |
| | kg/190° C.) |
| QCP PE5603 grey or ivory | HDPE DSD329 circular MFR |
| | 0.2-1.0 (2.16 kg/190° C.) |
| Kraton G1657MS | SEBS (ca. 13% Styrene content, |
| | MFR 22 g. 10 min (2.16 |
| | kg/230° C.) |
| Steamic OOSd (talc) | Fine talcum |
| Masterbatch Irganox B225 30% | 30% Irganox B225 in PP |
| Exxon Exxelor PE1040 | MAh grafted PE MFR 1 g/10 min |
| | (2.16 kg/190° C.) |
| DBPH 10% on PP | 10% 2,5-Dimethyl-2,5-di(tert- |
| | butylperoxy)hexane in PP |

TABLE 1

| Sample | | C1 | C2 | C3 | 4a | 4b | 4c | 4d | C5 | C6 | C7 |
|---|---|---|---|---|---|---|---|---|---|---|---|
| QCP PP300U (MFR 70) grey or | % | | | | 71.0 | 71.0 | 71.0 | 71.0 | | | |
| ivory | | | | | | | | | | | |
| QCP PP300t (MFR 50) grey or | % | 89.8 | 87.8 | 85.8 | | | | | 69.8 | 89.8 | 69.8 |
| ivory | | | | | | | | | | | |
| LyondellBasell Hifax X 1956 A | % | | | | 5.0 | 5.0 | 5.0 | 5.0 | | | |
| DOW Infuse 9077 | % | 5.00 | 5.00 | 5.00 | 20.00 | 20.00 | 20.00 | 20.00 | 10.00 | | |
| DOW Infuse 9177 | | | | | | | | | | 10.00 | 10.00 |
| QCP PE5603 grey or ivory | % | | | | | | | | 17.00 | | 20.00 |
| Kraton G1657MS | % | | 2.0 | 4.0 | | | | | 2.0 | | |
| Steamic OOSd (talc) | % | 5.00 | 5.00 | 5.00 | 3.00 | 3.00 | 3.00 | 3.00 | | | |
| Masterbatch Irganox B225 30% | % | 0.20 | 0.20 | 0.20 | 0.50 | 0.50 | 0.50 | 0.50 | 0.75 | 0.20 | 0.20 |
| Exxelor PE1040 | % | | | | | | | | 0.50 | | |
| DBPH 10% on PP | % | | | | 0.50 | 0.50 | 0.50 | 0.50 | | | |

TABLE 2

| Testing | | C1 | C2 | C3 | 4a | 4b | 4c | 4d | C5 | C6 | C7 |
|---|---|---|---|---|---|---|---|---|---|---|---|
| Aging before testing (HDPE | days | 14 | 14 | 14 | 14 | 14 | 14 | 14 | 14 | 14 | 14 |
| 3d/PP 14 d) | | | | | | | | | | | |
| Density ISO 1183 (T = 23° C.) | — | | | | | | | | | | |
| Density Average | kg/m³ | 943 | 943 | 941 | 923 | 922 | 922 | 924 | 919 | 912 | 920 |
| Density standard | kg/m³ | 0.80 | 0.50 | 0.80 | 0.577 | 0.000 | 3.055 | 0.577 | 0.000 | 0.900 | 1.200 |
| deviation | | | | | | | | | | | |
| Melt Flow ISO 1133 (I 2.16; 230 | — | | | | | | | | | | |
| C.) | | | | | | | | | | | |
| MFR | g/10 min | 41.4 | 39.9 | 39.4 | 30.6 | 30.7 | 30.5 | 30.3 | 14.5 | 37.4 | 18.6 |
| MVR | ml/10 min | 53.6 | 52.6 | 51.6 | 39.5 | 40.5 | 40.2 | 39.4 | 19.6 | 50.1 | 25.6 |
| Melt density | g/ml | 0.772 | 0.759 | 0.764 | 0.775 | 0.758 | 0.759 | 0.769 | 0.745 | 0.747 | 0.727 |
| Ash Content compounds | — | | | | | | | | | | |
| Ash content | % | 6.04 | 6.12 | 5.91 | 4.09 | 4.03 | 4.08 | 4.07 | 1.46 | 1.31 | 1.29 |
| Charpy (T = 23° C., II) | | | | | | | | | | | |
| Break type (C/P/N) | — | 5xC | 5xC | 5xC | 10xP | 10xP | 10xP | 10xP | 10xP | 5xC | 5xC |
| Charpy impact | kJ/m² | 5.68 | 7.21 | 8.33 | 56.41 | 56.27 | 56.2 | 56.7 | 46.11 | 7.82 | 13.74 |
| Charpy (T = −20° C., II) | | | | | | | | | | | |
| Break type (C/P/N) | — | 5xC | 5xC | 5xC | 10xC | 10xC | 10×C | 8xC | 10xC | 5xC | 5xC |
| Charpy impact | kJ/m² | 2.56 | 2.37 | 3.09 | 7.34 | 8.15 | 8.08 | 6.68 | 7.36 | 3.64 | 6.57 |
| Tensile ISO 527/1A (T = 23° C., II) | | | | | | | | | | | |
| E-Modulus | N/mm² | 1291 | 1230 | 1162 | 826 | 842 | 830 | 839 | 779 | 1044 | 868 |
| (Chord 0.05%-0.25%) | | | | | | | | | | | |
| Tensile Strain at Break | % | 46.6 | 45.4 | 53.4 | 277.8 | 192.9 | 147.7 | 269.1 | 47.5 | 49.4 | 30.9 |
| (Elongation at Break) | | | | | | | | | | | |
| Tensile Strain at Yield | % | 6.6 | 6.9 | 7.2 | 7.6 | 7.4 | 7.4 | 7.4 | 10.2 | 7.1 | 8.3 |
| (Elongation at yield) | | | | | | | | | | | |
| Tensile stress at Break | N/mm² | 13.0 | 13.1 | 13.7 | 13.7 | 13.1 | 13.1 | 13.6 | 12.2 | 14 | 12.7 |
| Yield Stress | N/mm² | 23.2 | 22.4 | 21.4 | 16.2 | 16.4 | 16.4 | 16.4 | 17.9 | 22.0 | 19.4 |
| Tiger stripes/Surface defects | | | | | | | | | | | |
| High/medium/Low/None | | low | low | low | none | none | none | none | High | medium | high |

Charpy was performed according to NEN-ISO 179/eA, molded bar 527/1A

What is claimed is:

1. A polymer composition comprising:
(a) 60-80 wt % of a shifted recycled polypropylene (s-rPP);
(b) 0-0.03 wt % of a peroxide;
(c) 3-7 wt % of a heterophasic propylene ethylene copolymer; and
(d) 10-30 wt % of a polyolefin elastomer (POE);
wherein the amount of components (a) to (d) are defined relative to the sum of (a) to (d) of the polymer composition, and wherein the melt flow rate (MFR) of component (a) ranges between 60 and 80 g/10 min. determined according to ISO 1133 at 2.16 kg at 230° C.

2. The polymer composition according to claim 1, wherein the polymer composition further comprises (e) between 1 and 5 wt % talcum, having a D50 of less than 4 microns.

3. The polymer composition according to claim 1, wherein the MFR of component (a) is in the range of 65 to 75 g/10 min., determined according to ISO 1133 at 2.16 kg at 230° C.

4. The polymer composition according to claim 1, wherein the s-rPP is obtained by shifting a recycled PP, obtained from PP plastic waste collected under DSD 324 (05-2012) and DSD 324-1 standards, with an organic peroxide.

5. The polymer composition according to claim 1, wherein the MFR of component (a) has been increased by reaction with of a recycled PP with an organic peroxide, prior to blending components (a) to (d).

6. The polymer composition according to claim 1, wherein component (a) is present between 60-77.5 wt %, relative to the sum of (a) to (d) of the polymer composition.

7. The polymer composition according to claim 1, wherein component (b) is an organic peroxide.

8. The polymer composition according to claim 1, wherein the sum of the amounts of components (a)+(b)+(c)+(d) is at least 90 wt % of the polymer composition.

9. The polymer composition according to claim 1, wherein component (c) has:
i) a content of ethylene derived units ranging from 6.0 wt % to 16.0 wt %;
ii) a fraction soluble in xylene at 25° C. ranging from 15 wt % to 45 wt %;
iii) an intrinsic viscosity (n) of the fraction soluble in xylene at 25° C. ranging from 4.0 to 9.0 dl/g; and
iv) a melt flow rate, measured according to ISO 1133 at 230° C. with a load of 2.16 kg, ranging from 0.3 to 50.0 g/10 min.

10. The polymer composition according to claim 1, wherein component (c) is used in amounts between 4-6 wt %, relative to the sum of (a) to (d) of the polymer composition.

11. The polymer composition according to claim 1, wherein component (d) is selected from the group consisting of C2-C4 copolymers, C2-C6 copolymers, and C2-C8 copolymers.

12. The polymer composition according to claim 1, wherein component (d) is present between 15-25 wt %, wherein wt % is relative to the sum of (a) to (d) of the polymer composition.

13. A process for preparing a polymer composition, wherein (i) the polymer composition is according to claim 1, (ii) in a first step, the MFR of component (a) is increased by reaction of a recycled PP, obtained from PP plastic waste collected under DSD 324 (05-2012) and DSD 324-1 standards, with a peroxide to be in the range of 60 to 80 g/10 min. determined according to ISO 1133 at 2.16 kg at 230° C., and (iii) in a second step, components (a)-(d) are added and blended.

14. An article made from the composition according to claim 1.
